(19) United States
(12) Patent Application Publication
(10) Pub. No.: US 2024/0344589 A1
(43) Pub. Date: Oct. 17, 2024

(54) Rotary Damper for Reducing and in Particular Braking a Rotational or Pivotal Movement of a Second Component Rotatable Relative to a First Component

(71) Applicant: Illinois Tool Works Inc., Glenview, IL (US)

(72) Inventor: Christian BECK, Röttingen (DE)

(21) Appl. No.: 18/606,883

(22) Filed: Mar. 15, 2024

(30) Foreign Application Priority Data
Apr. 13, 2023 (DE) 10 2023 109 292.8

(51) Int. Cl. F16F 15/12

(52) U.S. Cl. CPC F16F 15/1204; F16F 15/1208

(57) ABSTRACT

The disclosure relates to a rotary damper (1) for reducing and in particular braking a rotational or pivotal movement of a second component rotatable relative to a first component. The rotary damper (1) includes a first damper component (2), which is in particular fixedly connected or connectable to the first part, a second damper component (3), which is particular fixedly connected or connectable to the first second part, and a damping mechanism (4). The first damper component (2) is rotatable relative to the second damper component (3). In a first direction of rotation, a rotational movement of the first damper component (2) relative to the second damper component (3) is or can be braked due to the damping mechanism (4). According to the disclosure, it is provided in particular that the rotary damper (1) further includes a coupling mechanism (5), which is configured so as to operatively connect the second damper component (3) to the damping mechanism (4) upon a movement of the first damper component (2) relative to the second damper component (3) in the first direction of rotation, and, upon a movement of the first damper component (2) relative to the second damper component (3) in a second direction opposite the first direction of rotation, to release and/or prevent an operative connection between the second damper component (3) and the damping mechanism (4).

### RELATED APPLICATION

The present application claims the benefit of German Patent Application No. 10 2023 109 292.8, filed Apr. 13, 2023, titled “Rotary Damper for Reducing and in Particular Braking a Rotational or Pivotal Movement of a Second Component Rotatable Relative to a First Component,” the contents of which are hereby incorporated by reference.

### BACKGROUND

In recent years, damper apparatuses have been developed in order to slow and/or control a relative movement of parts to one another. For example, vehicles are often equipped with various pivot assemblies (e.g., tailgates, freight doors, glove compartments, center console lids, engine hoods, etc.). The parts of such pivot assemblies are connected to one another in order to rotate relative to one another, and one or more damper apparatuses are connected to the parts in order to regulate their rotational speed.

Certain known damper apparatuses are designed so as to dampen, i.e., decelerate the relative movement of parts that pivot due to gravity. If a part located further below (e.g., a glove box flap) is released in order to pivot relative to a part located further above (e.g., a dashboard), the damper apparatus slows the downwards rotation of the lower part.

Such damper apparatuses known in the prior art are often configured as air dampers or hydraulic dampers, in which a working medium (air, hydraulic fluid, or grease) is forced from a first working space into a second working space through an orifice or choke, as a result of which a force/motion introduced into the damper apparatus is dampened, i.e., reduced/braked.

Rotary dampers are also generally known, whose functionality is based on the shear principle. A rotary damper, also known as a rotational viscous damper or rotational hydraulic damper, is a mechanical device designed to control the speed or motion of a rotating object. It works by generating resistance to rotational motion, thereby damping or slowing down the movement of the object it is attached to.

The known damper apparatuses naturally have a relatively complex construction, in which the scaling of the working spaces must be ensured. In particular, in the case of the generally known damper apparatuses, which are in particular embodied as air dampers or hydraulic dampers, there is a risk that the systems will leak after a time and thus lose their damping function. Moreover, damper apparatuses that operate with liquid working media, such as oils, have the disadvantage that the damping behavior is often temperature-dependent, because the viscosity of the damping medium or damping liquid increases at low temperatures.

In particular, linear dampers containing a rotary damper are known from the prior art, and in particular serve to slow or dampen movements of parts, for example glove box lids or movable flaps. For example, such linear dampers with rotary dampers contained therein are described in the publications EP0846886B1, EP1344958B1, and DE102006000950B4. Conventional rotary dampers typically comprise a rotor which is rotatably mounted inside the rotary damper. A brake fluid, e.g., silicone oil, between the rotor and an outer wall of the rotary damper provides a braking damping when the rotor rotates in the rotary damper.

A pinion is typically seated on the rotor shaft and meshes with a tooth segment that is part of a rack, for example. Such a rotary damper is often attached in a stationary part of the housing. A linear guide is furthermore provided for the rack and is mounted such that it can pivot about the axis of the rotor shaft and holds the rack in engagement with the pinion, namely regardless of the rotational position of the rack. The guide enables a translatory movement of the rack in the guide and thus causes a corresponding rotation of the pinion. Any pivoting of the rack is absorbed by the rotating guide. Any movement of the part to be damped therefore results in linear movement in the guide and a corresponding damping by the rotary damper.

A rotary damper of the type considered herein is also known from publication DE4209821A1, for example. The rotary damper known from this prior art comprises a plate-shaped housing with a circular recess in which a rotor with a rotating part attached thereto is arranged, wherein the rotor with the rotating part attached thereto is rotatably supported within a circular recess. The rotor comprises a shaft rising from the rotating part. It is connected to a rotating or sliding part to be dampened in its movement, for example the cover of a glove compartment or a movable ashtray in a motor vehicle, in order to accommodate the rotational movement of the rotating part or sliding part. To dampen the movement of the rotating or sliding part, an annular clastic portion is arranged in the circular recess of the housing along the inner circumference of the circular recess. At the outer circumference of the rotating part of the rotor, indentations are provided in which balls or rollers are mounted, that compress within the periphery of the annular elastic portion upon rotation of the rotor, thereby damping rotation of the rotor and damping movement of the rotating or sliding part attached to the shaft of the rotor.

In one embodiment of this rotary damper, which is generally known from the prior art and is described for example in publication DE4208921A1, it is provided that damping of the rotational movement of the rotor within the housing occurs only in one direction of rotation, but the rotor can freely rotate in the opposite direction of rotation. This known rotary damper thus generates a braking torque when the rotor rotates in a first direction of rotation and has a freewheeling effect when the rotor rotates in the opposite direction of rotation.

The rotary damper described above and known for example from the publication DE4209821A1 proves to be unreliable in practical use and very complex in its manufacture and assembly. In particular, the insertion of the balls or rollers into the indentations of the rotating part attached to the rotor proves to be time consuming and requires some skill in assembling this rotary damper.

On the other hand, a one-way braking apparatus is known from publication EP1344985A1, which comprises a rotary damper in which a braking torque is generated in a first direction of rotation of the rotary damper and freewheeling is present in the opposite direction of rotation. The rotary damper is a fluid damper having a housing in which there is a viscous fluid, such as silicone oil. A brake rotor is rotatably mounted within the housing. When the rotor rotates, the viscous fluid creates a resistance that makes itself felt as a braking torque. The rotary damper can be connected to a rotating or sliding part, for example a glove box cover in a vehicle, to be braked in its movement via a shaft that extends out of the housing and is coupled to a toothed rack or a toothed segment via a gearwheel.

In the one-way braking apparatus known from the publication EP1344958A1, a freewheeling of the braking apparatus is generated between the housing of the rotary damper and a further housing that receives the rotary damper. The rotary damper is mounted in a floating manner in a chamber of the further housing and a form-fit coupling is produced between the periphery of the housing of the rotary damper and a portion of the inner wall of the chamber receiving the rotary damper when the rotary damper rotates in a first direction of rotation. In the opposite direction of rotation, the coupling between the housing of the rotary damper and the inner periphery of the chamber of the further housing is lifted so that the rotary damper can freely rotate in the opposite direction of rotation in the further housing without impacting a braking torque.

This one-way braking apparatus also proves to be complex in its construction and assembly. In addition, this one-way braking apparatus proves to be disadvantageous when using a fluid rotary damper because the braking torque depends greatly on the ambient temperature due to the temperature dependence of the viscosity of the damping fluid. This can cause problems, in particular in vehicles, because high temperature differentials can occur there. The positive coupling of the housing of the rotary damper to the further housing, which can in particular be configured as a toothing, furthermore leads to undesirable noises.

Based on the aforementioned disadvantages in the prior art, the disclosure addresses the problem of providing a rotary damper with freewheeling that is as simple as possible and is as easy to assemble as possible and at the same time is as smooth and quiet as possible when in use and generates a largely temperature-independent braking torque.

In particular, the present disclosure addresses the problem of specifying a damper apparatus configured as a rotary damper for reducing/damping the movement of a part, which offers a wide range of possible uses. There is also a need for damping apparatuses with a simple construction so that the damping apparatus can be manufactured and assembled inexpensively, while at the same time achieving a damping capability that is as independent of temperature to the extent possible.

### SUMMARY

The present disclosure generally relates to a rotary damper, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, the exemplary embodiment of the rotary damper according to the disclosure.

FIG. 2 illustrates schematically and in a side view, the exemplary embodiment of the rotary damper according to the disclosure according to FIG. 1.

FIG. 3 illustrates schematically and in an isometric view, the exemplary embodiment of the rotary damper according to the disclosure according to FIG. 1, without the first damper component.

FIG. 4 illustrates schematically and in a side view, the exemplary embodiment of the rotary damper according to the disclosure according to FIG. 1, without the first damper component and without the fin or rib structure of the damping mechanism.

FIG. 5 illustrates schematically and in an isometric view, the bearing structure for the fin or rib structure of the damping mechanism of the exemplary embodiment of the rotary damper according to FIG. 1.

FIG. 6 illustrates schematically, a cross-sectional view along line B-B in FIG. 4 for clarification of components of the coupling mechanism of the exemplary embodiment of the rotary damper according to the disclosure according to FIG. 1, wherein however the blocking bodies of the coupling mechanism are not shown in FIG. 6 for the sake of clarity.

FIG. 7 illustrates schematically and in an isometric view, the engagement structure of the second damper component of the exemplary embodiment of the rotary damper according to the disclosure according to FIG. 1.

FIG. 8 illustrates schematically and in an isometric view, a blocking body of the coupling mechanism of the exemplary embodiment of the rotary damper according to FIG. 1.

FIG. 9 illustrates schematically and in a top plan view, the blocking body of the coupling mechanism according to FIG. 8.

FIG. 10A illustrates schematically and in a cross-sectional view, a portion of the coupling mechanism of the exemplary embodiment of the rotary damper according to the disclosure, with the blocking bodies inserted, each of which are in their freewheeling position.

FIG. 10B illustrates schematically, the cross-sectional view of the coupling mechanism according to FIG. 10A, wherein however the blocking bodies are in their engagement position here.

FIG. 11A illustrates schematically, a further cross-sectional view through the coupling mechanism of the exemplary embodiment of the rotary damper according to FIG. 1, wherein the blocking bodies are each in their respective freewheeling position.

FIG. 11B illustrates schematically, the cross-sectional view according to FIG. 11A, wherein however the blocking bodies are each in their engagement position.

FIG. 12A illustrates schematically, a cross-sectional view along line A-A in FIG. 4, wherein the blocking bodies of the coupling mechanism are each in their respective freewheeling position.

FIG. 12B illustrates schematically, the cross-sectional view according to FIG. 12A, wherein however the blocking bodies are respectively in their engagement position.

FIG. 13 illustrates schematically, a cross-sectional view along line D-D in FIG. 2.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure relates generally to movement control apparatuses and in particular to movement control apparatuses in the form of damper apparatuses which are configured for reducing or braking (“decelerating”) a movement of a second part that is movable relative to a first part.

Accordingly, the damper apparatus according to the disclosure is in particular a rotary damper for reducing and in particular braking a rotational or pivotal movement of a second part rotatable relative to a first part.

The rotary damper is suitable, for example, for damping, i.e., braking/reducing, pivoting flaps arranged within the interior of a vehicle, or, for example, glove box lids.

The rotary damper according to the disclosure is in particular characterized in that it produces a freewheeling in a direction of rotation. The movement of the part to be dampened is then only transferred in a direction of rotation. In the opposite direction of rotation, the part is decoupled from the damping mechanism so that the movement of the part in this direction of rotation is undamped and possible with only a little force.

Such an opening movement of a flap can be damped, for example, whereas the closing movement of the flap is carried out without a braking effect and thus without damping.

The rotary damper according to the disclosure comprises a first damper component, which is in particular fixedly connected or connectable to the first part, a second damper component, which is particular fixedly connected or connectable to the second part, and the aforementioned damping mechanism.

The first damper component is rotatable or pivotable relative to the second damper component, wherein, in a first direction of rotation, a rotational movement of the first damper component relative to the second damper component is or can be braked due to the damping mechanism.

In order to realize the freewheeling function, it is provided according to the disclosure that the rotary damper further comprises a coupling mechanism, which is configured so as to operatively connect the second damper component to the damping mechanism upon a movement of the first damper component relative to the second damper component in the first direction of rotation, and, upon a movement of the first damper component relative to the second damper component in a second direction opposite the first direction of rotation, to release and/or prevent an operative connection between the second damper component and the damping mechanism.

In a particularly easy to realize yet effective manner, the coupling mechanism comprises a ratchet.

Preferably, the ratchet is transferable between an engagement position and a freewheeling position. In particular, according to design variants of the rotary damper according to the disclosure, it is provided that, when the first damper component is moved relative to the second damper component in the first direction of rotation, the ratchet is present in the engagement position in which the ratchet is operatively connected to the second damper component by a form fit. By contrast, when the first damper component moves relative to the second damper component in the second direction of rotation, the ratchet is present in the freewheeling position, in which a form-fit operative connection between the ratchet is released or prevented.

In this way, in order to realize the freewheeling function, it is possible that the operative connection between the second damper component and the damping mechanism is released or prevented when the first damper component moves relative to the second damper component in the second direction of rotation.

Particularly preferably, it is further provided here that the ratchet is configured to automatically assume the engagement position when the first damper component is moved relative to the second damper component in the first direction of rotation and to automatically assume the freewheeling position when the first damper component is moved relative to the second damper component in the second direction of rotation.

In an alternative or supplementary design variant of the rotary damper according to the disclosure, it is provided that the coupling mechanism or the ratchet of the coupling mechanism comprises at least one blocking body, which is mounted in a floating manner such that the blocking body is transferable between an engagement position and a freewheeling position.

In particular, it is provided that, when the first damper component is moved relative to the second damper component in the first direction of rotation, the at least one blocking body is present in the engagement position, in which the at least one blocking body is operatively connected to the second damper component by a form fit. By contrast, when the first damper component is moved relative to the second damper component in the second direction of rotation, the at least one blocking body is present in the freewheeling position, in which a form-fit operative connection between the at least one blocking body and the second damper component is released or prevented.

According to preferred implementations of the rotary damper according to the disclosure, the latter or the coupling mechanism of the rotary damper comprises a plurality of, in particular three, identically arranged blocking bodies of the aforementioned type, which are respectively mounted in a floating manner, so that each blocking body can be transferred between an engagement position and a freewheeling position. The blocking body and its (floating) bearing are selected such that each blocking body is in the corresponding engagement position when the first damper component is moved relative to the second damper component in the first direction of rotation. Likewise, all of the blocking bodies are in their corresponding freewheeling position when the first damper component is moved relative to the second damper component in the second direction of rotation.

The provision of preferably three blocking bodies, which are identical in construction, has the advantage that, in the corresponding engagement position, the blocking bodies produce the form-fit operative connection with the second damper component as evenly as possible. Of course, it is also contemplated to provide a different number of blocking bodies.

On the other hand, this embodiment is characterized in particular by its simplicity. The coupling mechanism, with which the freewheeling of the rotary damper is realized, consists merely of the correspondingly floatingly mounted blocking bodies. The arrangement and geometry of the parts allows for a straightforward linear assembly.

It is provided in particular that the at least one blocking body and preferably all blocking bodies of the coupling mechanism is/are configured so as to automatically assume the engagement position when the first damper component is moved relative to the second damper component in the first direction of rotation and automatically assume the freewheeling position when the first damper component is moved relative to the second damper component in the second direction of rotation.

With respect to the at least one blocking body of the coupling mechanism, according to a preferred implementation of the rotary damper according to the disclosure, it is provided that the blocking body comprises a preferably cylindrical or at least substantially cylindrical base body. However, the disclosure is not limited to a cylindrical shape of the base body. A frusto-conical base body or the like would also be conceivable, for example. However, the base body should generally be designed at least substantially in a rotationally symmetrical manner.

The base body has a first toothing on its lateral surface, which is configured so as to engage with an engagement structure of the second damper component in a form-fit manner or at least substantially in a form-fit manner in the engagement position of the blocking body.

In this context in particular, it is conceivable that the at least one first toothing of the base body of the blocking body comprises at least one first tooth and preferably a plurality of first teeth distributed in an equidistant manner about the circumference of the lateral surface of the base body. Here, it can be appreciated that the first tooth or teeth of the first toothing of the base body of the blocking body are embodied as pawls for the formation of a rotary ratchet. This means that each first tooth of the first toothing of the base body of the blocking body has a steep flank and a flat flank.

As already stated, the base body of the blocking body is operatively connected to the engagement structure of the second damper component and thus to the second damper component via the first toothing in the engagement position of the blocking body.

On the other hand, it is provided that the base body of the at least one blocking body is also operatively connected to the damping mechanism at least in the engagement position of the at least one blocking body, such that a rotational movement of the second damper component relative to the damping mechanism is then interrupted or prevented. In other words, in the engagement position of the at least one blocking body, the damping mechanism is operatively connected to the second damper component and is no longer rotatable relative to the second damper component.

By contrast, according to design variants, if the base body of the at least one damper component is not operatively connected to the engagement structure of the second damper component in the freewheeling position of the at least one blocking body, then the base body of the at least one blocking body can still be operatively connected to the damping mechanism. However, in this situation, a rotational movement of the second damper component relative to the damping mechanism is possible, because the second damper component is decoupled from the damping mechanism, because the at least one blocking body is present not in the engagement position but in the freewheeling position.

In particular, it is thus provided that the at least one blocking body is supported in a floating manner and the at least one first tooth of the blocking body and the engagement structure of the second damper component are configured such that, upon a movement of the first damper component relative to the second damper component in the second direction of rotation, the at least one first toothing of the blocking body slips or slides across the engagement structure of the second damper component, so that there is no operative connection between the blocking body and the engagement structure of the second damper component or the second damper component.

On the other hand, when the first damper component is moved relative to the second damper component in the first direction of rotation, the at least one first tooth of the blocking body strikes against a tooth of the engagement structure of the second damper component and thus produces a form fit with the engagement structure of the second damper component and thus indirectly at least with the second damper component, as a result of which a rotation of the second damper component relative to the blocking body is interrupted. This establishes the operative connection between the at least one blocking body and the second damper component.

According to a further development of the aforementioned design variants of the rotary damper according to the disclosure, it is provided that the base body of the at least one blocking body is provided with a further (second) toothing on its lateral surface, which toothing is configured so as to be operatively connected to the bearing structure of the damping mechanism at least in the engagement position of the at least one blocking body, preferably in a form-fit manner and even more preferably in a substantially form-fit manner.

In particular, it is provided that the teeth of the second toothing of the blocking body are different from the teeth of the first toothing of the blocking body. As already stated, with regard to the first teeth of the first toothing, it is advantageous when they are designed as a pawl with a steep and a flat flank per tooth. By contrast, for the toothing of the second gear, the flanks of each tooth can be the same as for a gearwheel.

The damping mechanism preferably comprises a fin or rib structure, in particular made of an elastically deformable plastic material, for example a rubber or gum material. The fin or rib structure comprises a plurality of protruding regions, for example fins, fingers, knobs, and/or ribs, which are elastically deflectable at least partially or regionally in the direction of movement of the first damper component.

By providing such a fin or rib structure for the damping mechanism, it is advantageously enabled that the damping mechanism does not function based on a displacement of a working fluid, in particular a hydraulic fluid (oil or grease), or on a gas, in particular air.

The damping mechanism is thus substantially easier to implement in a constructive respect, wherein, at the same time, a damping characteristic of the damper apparatus is in particular individually, i.e., user-specifically, adjustable in a particularly efficient manner. Moreover, the damping characteristic of the rotary damper is largely independent of ambient conditions, in particular temperature.

Upon a rotational motion of the first damper component relative to the damping mechanism operatively connected to the second damper component, the fins, fingers, knobs, and/or ribs of the fin or rib structure of the damping mechanism slide over the first damper component. The damping mechanism is based on a functionality in which at least a part of the kinetic energy introduced into the damping mechanism via the first damper component is converted into thermal energy by elastic deformation or is converted into thermal energy by frictional work. Preferably, the fins, fingers, knobs, and/or ribs, i.e., the protruding regions of the fin or rib structure are formed from an elastic material, in particular a plastic material, whose elasticity varies only slightly over a temperature range, as far as possible.

Preferably, the damping mechanism further comprises a bearing structure for the fin or rib structure. The bearing structure is preferably formed from a harder material, in particular a plastic material.

As already indicated, with regard to the coupling mechanism, it is advantageous that the at least one blocking body comprises a further, second toothing, which is configured so as to be operatively connected to the bearing structure of the damping mechanism, at least in the engagement position of the blocking body, preferably in a form-fit manner and even more preferably in a substantially form-fit manner.

It can be appreciated here that the bearing structure of the damping mechanism comprises a toothing that is configured at least partially or regionally complementary to the second toothing of the at least one blocking body and is configured so as to establish a form-fit or at least substantially form-fit connection with the second toothing of the blocking body at least in the engagement position of the at least one blocking body and preferably in the engagement position as well as the freewheeling position of the at least one blocking body.

With respect to the floating bearing of the blocking body, according to implementations of the rotary damper according to the disclosure, it is provided that the blocking body is mounted in a floating manner in a guide which is configured as an elongated hole, such that the blocking body is in a position closer to the engagement structure of the second damper component in comparison to the position in which the blocking body is in its freewheeling position.

The engagement structure of the second damper component comprises at least one toothing, which is preferably at least substantially complementary to the at least one first tooth of the at least one first toothing of the blocking body.

Preferably, the toothing of the engagement structure of the second damper component is also embodied as a pawl, i.e., with teeth, each having a steep and flat flank, so that upon movement of the first damper component relative to the second damper component in the second direction of rotation, the blocking body can slide across the engagement structure of the second damper component.

According to a preferred implementation of the rotary damper, the first damper component is embodied as an in particular cylindrical hollow body, wherein the damping mechanism is preferably partially or regionally received in the in particular cylindrical hollow body of the first damper component, preferably coaxially or concentrically.

The second damper component is arranged at an end region of the first damper component, which is embodied as an in particular cylindrical hollow body. The second damper component is connected, and in particular operatively connected, to the first damper component and/or to the damping mechanism via the coupling mechanism.

The rotary damper according to the disclosure is characterized in particular in that, by providing identical blocking bodies in a simple manner, a freewheeling function can be implemented, wherein a particularly simple assembly of the rotary damper is possible. Moreover, many components of the freewheeling assembly can be integrated into the damper components at least in regions, which reduces manufacturing costs and significantly improves the overall pack size of the rotary damper, i.e., makes it smaller.

The exemplary embodiment of the damper according to the disclosure shown in the drawings is a rotary damper 1 for reducing and, in particular braking, a rotational or pivotal movement of a second part (not shown) that is rotatable relative to a first part (also not shown).

Briefly summarized, the rotary damper 1 comprises a first damper component 2, which is in particular fixedly connectable to the first part. The rotary damper 1 further comprises a second damper component 3, which is in particular fixedly connectable to the second part. In addition, a damping mechanism 4 is provided.

The first damper component 2 is rotatable relative to the second damper component 3, wherein the axis of rotation extends along the longitudinal extension axis of the rotary damper 1.

As will be described in further detail below, the rotary damper 1 shown in the drawings includes a freewheeling function. It is provided that rotational movement of the first damper component 2 relative to the second damper component 3 is or can be decelerated in a first direction of rotation due to the damping mechanism 4.

By contrast, when the first damper component 2 moves relative to the second damper component 3 in a second direction of rotation opposite to the first direction of rotation, there is no braking effect on the second damper component 3 caused by the damping mechanism 4.

In order to realize this freewheeling function, the rotary damper 1 comprises a coupling mechanism, which is configured so as to operatively connect the second damper 3 component to the damping mechanism 4 upon a movement of the first damper component 2 relative to the second damper component 3 in the first direction of rotation, and, upon a movement of the first damper component 2 relative to the second damper component 3 in the second direction of rotation which is opposite to the first direction of rotation, to release and/or prevent an operative connection between the second damper component 3 and the damping mechanism 4.

It is generally conceivable in this context that a coupling mechanism 5 of the exemplary embodiment of the rotary damper 1 according to the disclosure comprises a ratchet, which is transferable between an engagement position and a freewheeling position, wherein, when the first damper component 2 moves relative to the second damper component 3 in the first direction of rotation, the ratchet is present in the engagement position, in which the ratchet is operatively connected to the second damper component 3 by way of a form fit. On the other hand, when the first damper component 2 moves relative to the second damper component 3 in the second direction of rotation, the ratchet is present in the freewheeling position, in which a form-fit operative connection between the ratchet is released or prevented.

The construction and functionality of the coupling mechanism 5 or the ratchet, which is used in the exemplary embodiment of the rotary damper 1 according to the disclosure shown in the drawings, is described below with reference to the illustrations in FIG. 5 to FIG. 12B in particular.

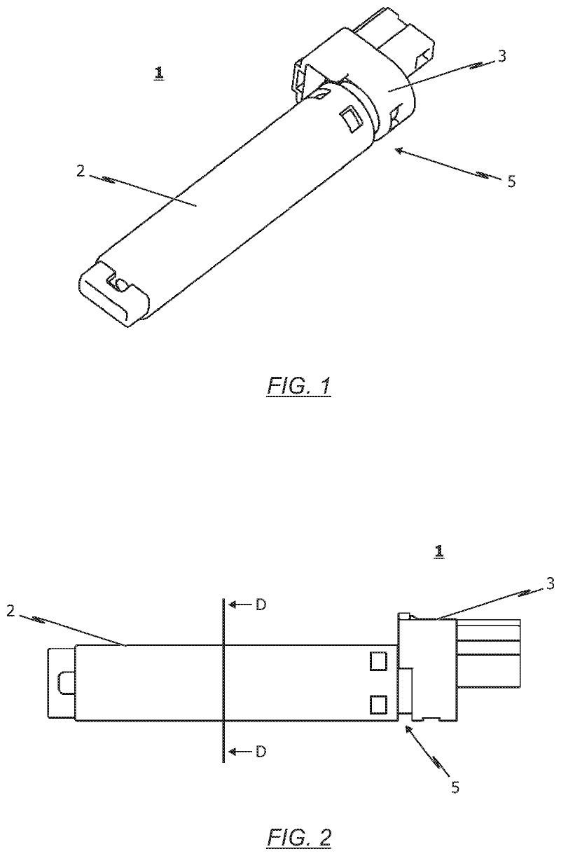

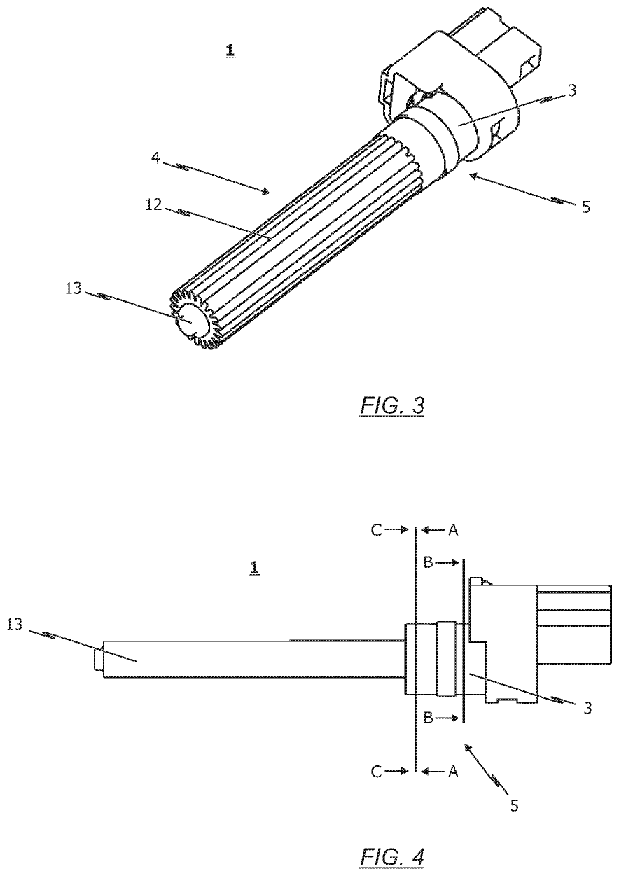

Specifically, in the exemplary embodiment of the rotary damper 1 according to the disclosure shown in the drawings, the first damper component 2 is embodied as an in particular cylindrical hollow body, as can be seen in the illustration in FIG. 1 or the illustration in FIG. 2.

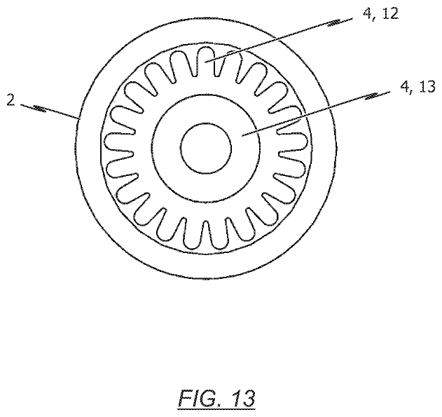

The damping mechanism 4 is in particular partially or regionally received in the in particular cylindrical hollow body of the first damper component 2 preferably coaxially or concentrically, as can be seen from the cross-sectional view in FIG. 13.

Specifically, the damping mechanism 4 comprises a fin or rib structure 12 as well as a bearing structure 13 associated with the fin or rib structure 12.

An isometric view of the bearing structure 13 is shown in FIG. 5. It consists of a long, pin-shaped region onto which the sleeve-shaped fin or rib structure 12 is stuck and connected to the shaft region. At an end region of the bearing structure 13, an engagement structure 14 associated with the coupling mechanism 5 is formed with an inner toothing.

The second damper component 3 is arranged at an end region of the first damper component 2, which is embodied as an in particular cylindrical hollow body. The second damper component 3 is operatively connected to the first damper component 2 and/or to the damping mechanism 4 via the coupling mechanism 5.

The fin or rib structure 12 of the damping mechanism 4 is preferably formed from an elastically deformable plastic material, for example a rubber material. At least upon movement of the first damper component 2 relative to the second damper component 3 in the first direction of rotation, the fin or rib structure 12 of the damping mechanism 4 cooperates with the first damper component 2 in such a way that at least a portion of the kinetic energy of the first damper component 2 is converted into heat and/or deformation work by cooperation with the fin or rib structure 12 of the damping mechanism 4.

The coupling mechanism 5, via which the second damper component 3 can be rotated in operative connection with the damping mechanism 4—depending on the direction of rotation of the first damper component 2 relative to the second damper component 3—comprises the aforementioned ratchet, which, in the exemplary embodiment of the rotary damper 1 according to the disclosure, is formed specifically by three identical blocking bodies 6.

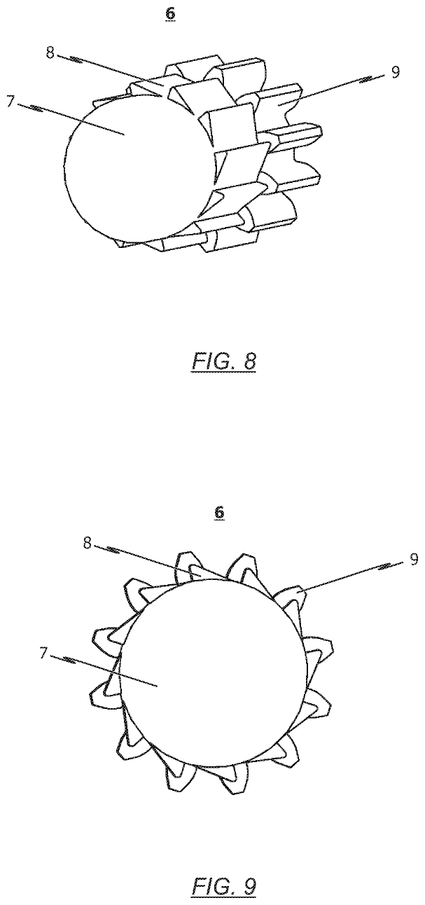

An isometric view of such a blocking body 6 is shown in FIG. 8, while FIG. 9 shows a top plan view of the blocking body 6.

The blocking body 6 preferably comprises a cylindrical or at least substantially cylindrical base body 7, wherein the base body 7 is provided with a first toothing 8 on its lateral surface as well as a second toothing 9.

The first toothing 8 is configured so as to cooperate with an engagement structure 10 of the second damper component 3, while the second toothing 9 of the blocking body 6 serves to cooperate with the engagement structure 14 of the bearing structure 13 of the damping mechanism 4.

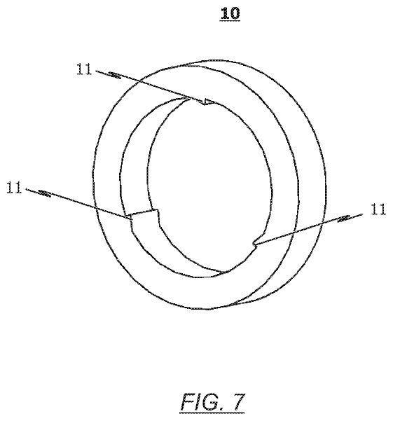

In FIG. 7, in an isometric view, the engagement structure 10 of the second damper component 3 is shown.

As shown, the engagement structure 10 comprises a total of three tooth regions, wherein each tooth region is formed from a flat and a steep flank, thus forming a type of “locking latch.”

On the other hand, the teeth of the first toothing 8 of the blocking body 6 are also configured as a locking latch, thus having a steep and a flat flank in each case.

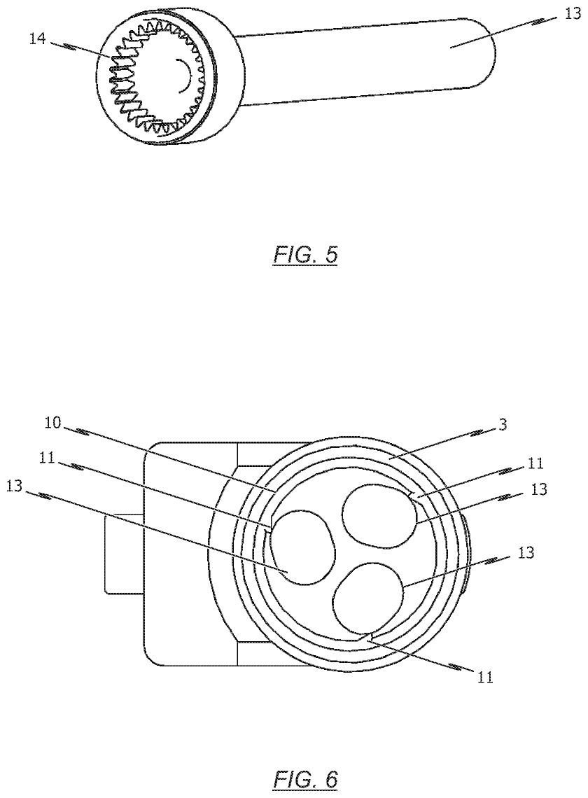

Each blocking body 6 of the coupling mechanism 5 is mounted in a floating manner such that the blocking body 6 is transferable between an engagement position and a freewheeling position. The floating bearing is realized by elongated holes, as indicated in FIG. 6.

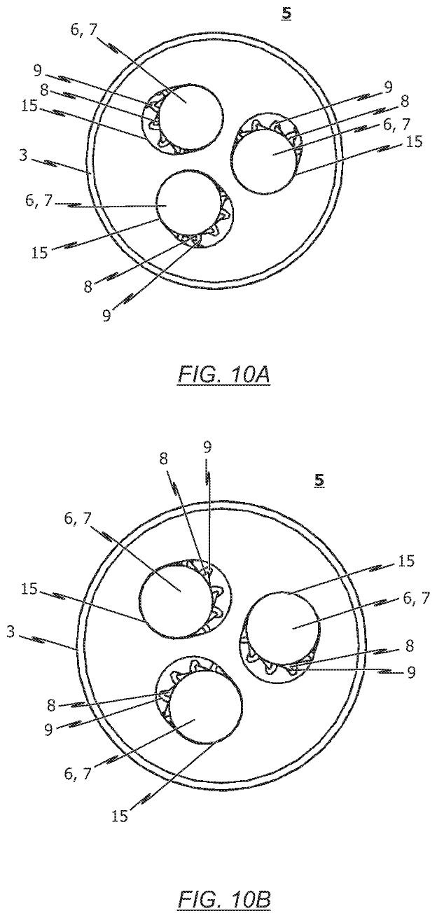

FIG. 10A shows a cross-sectional view of how the blocking bodies 6 are arranged in their freewheeling position. FIG. 10B shows the same teeth, wherein however the blocking body 6 is present here in its engagement position.

Upon movement of the first damper component 2 relative to the second damper component 3 in the first direction of rotation, the blocking body 6 is in its engagement position, in which the blocking body 6 is operatively connected by a form fit with the second damper component 3 or with the engagement structure 10 of the second damper component 3, respectively.

When the first damper component 2 is moved relative to the second damper component 3 in the second direction of rotation, however, the blocking body 6 is in its freewheeling position, in which a form-fit operative connection between the blocking bodies 6 and the second damper component 3 or the engagement structure 10 of the second damper component 3 is released or prevented.

Here, it is provided in particular that the blocking bodies 6 automatically assume the engagement position when the first damper component 2 is moved relative to the second damper component 3 in the first direction of rotation and automatically assume the freewheeling position when the first damper component 2 is moved relative to the second damper component 3 in the second direction of rotation.

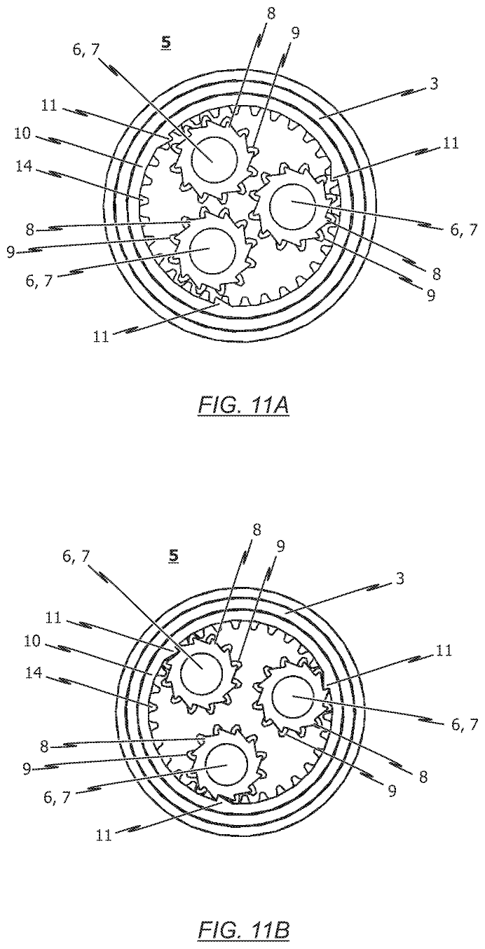

In the engagement position, each blocking body 6 is engaged in a form-fit manner with the engagement structure 10 of the second damper component 3 via the first toothing 8, and in particular with the teeth of the engagement structure 10 of the second damper component 3, as can be seen in the cross-sectional view in FIG. 11B. In this engagement position, a rotational movement of the second damper component 3 relative to the damping mechanism 4 is interrupted or prevented.

The blocking bodies 6 are supported in a floating manner in such a way that, upon movement of the first damper component 2 relative to the second damper component 3 in the second direction of rotation, the teeth of the first toothing 8 of the blocking body 6 slide across the engagement structure 10 of the second damper component 3, while upon movement of the first damper component 2 relative to the second damper component 3, the teeth of the first toothing 8 of the blocking body 6 strike against a tooth of the engagement structure 10 of the second damper component 3 in the first direction of rotation, producing a corresponding form fit and interrupting a rotation of the second damper component 3 relative to the blocking body 6 or relative to the damping mechanism 4.

The second toothing 9 of the blocking body 6 is configured so as to be operatively connected with the bearing structure 13 of the damping mechanism 4 via the engagement structure 10 of the bearing structure 13 of the damping mechanism 4 at least in the engagement position of the blocking body 6 and preferably in a form-fit manner even more preferably in a substantially form-fit manner.

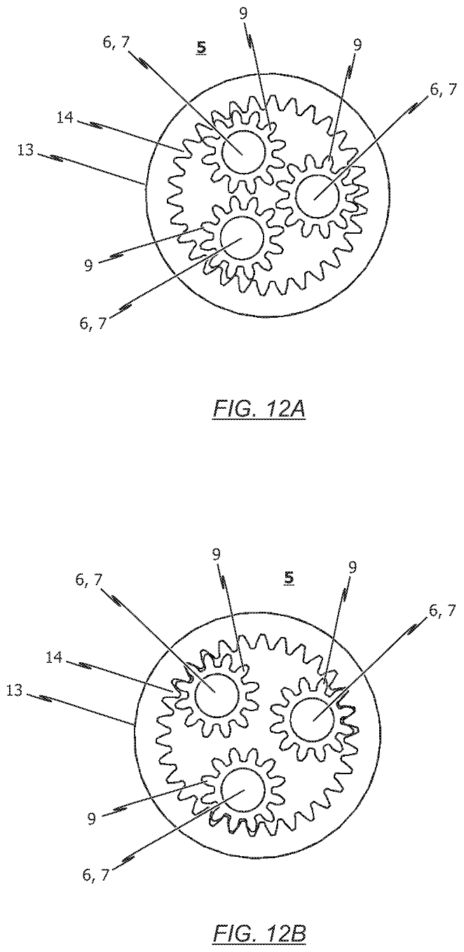

As shown in the sectional views in FIGS. 12A and 12B, an operative connection is present between the second toothing 9 of the blocking body 6 and the engagement structure 10 of the bearing structure 13 of the damping mechanism 4 not only in the engagement position of the blocking body 6 but also in the freewheeling position of the blocking body 6.

The engagement structure 10 of the bearing structure 13 of the damping mechanism 4 has a toothing that is at least partially or regionally complementary to the second toothing 9 of the blocking body 6 and is configured so as to produce a form-fit or at least substantially form-fit connection with the blocking bodies 6 via the corresponding second toothing 9 at least in the engagement position of the blocking body 6 and preferably in both the engagement position and the freewheeling position of the blocking body 6.

The guides 15, which are embodied as an elongated hole with which the blocking bodies 6 are supported in a floating manner, are configured such that the blocking bodies 6 are in a position closer to the engagement structure 10, 14 of the second damper component 3 in their engagement position compared to the position in which the blocking bodies 6 are in their freewheeling position, as shown by a comparison of FIG. 10A and FIG. 10B.

While the present device and/or system has been described with reference to certain implementations, it will be understood by those skilled in the art that various changes may be made and equivalents may be substituted without departing from the scope of the present device and/or system. In addition, many modifications may be made to adapt a particular situation or material to the teachings of the present disclosure without departing from its scope. For example, components of disclosed examples may be combined, divided, re-arranged, and/or otherwise modified. Therefore, the present device and/or system are not limited to the particular implementations disclosed. Instead, the present device and/or system will include all implementations falling within the scope of the appended claims, both literally and under the doctrine of equivalents.

### LIST OF REFERENCE NUMERALS

1 Rotary damper
2 First damper component
3 Second damper component
4 Damping mechanism
5 Coupling mechanism
6 Blocking body
7 Base body of the blocking body
8 First toothing of the blocking body
9 Second toothing of the blocking body
10 Engagement structure of the second damper component
11 Toothing of the engagement structure of the second damper component
12 Fin or rib structure of the damping mechanism
13 Bearing structure of the damping mechanism
14 Engagement structure of the bearing structure
15 Guide

What is claimed is:

1. A rotary damper (1) for reducing and in particular braking a rotational or pivotal movement of a second component rotatable relative to a first component, wherein the rotary damper (1) comprises the following:
a first damper component (2), which is in particular fixedly connected or connectable to the first component;
a second damper component (3), which is in particular fixedly connected or connectable to the second component;
a damping mechanism (4),
wherein the first damper component (2) is rotatable relative to the second damper component (3),
wherein, in a first direction of rotation, a rotational movement of the first damper component (2) relative to the second damper component (3) is or can be braked due to the damping mechanism (4), and
wherein the rotary damper (1) further comprises a coupling mechanism (5), which is configured so as to operatively connect the second damper component (3) to the damping mechanism (4) upon a movement of the first damper component (2) relative to the second damper component (3) in the first direction of rotation, and, upon a movement of the first damper component (2) relative to the second damper component (3) in a second direction of rotation opposite the first direction of rotation, to release and/or prevent an operative connection between the second damper component (3) and the damping mechanism (4).

2. The rotary damper (1) according to claim 1,
wherein the coupling mechanism (5) comprises a ratchet, which is transferable between an engaged position and a freewheeling position, wherein, upon a movement of the first damper component (2) relative to the second damper component (3) in the first direction of rotation, the ratchet is in the engaged position, in which the ratchet is operatively connected in a form-fit manner to the second damper component (3), and wherein, upon a movement of the first damper component (2) relative to the second damper component (3) in the second direction of rotation, the ratchet is in the freewheeling position, in which a form-fit operative connection between the ratchet and the second damper component is released or prevented.

3. The rotary damper (1) according to claim 2,
wherein the ratchet is configured to automatically assume the engaged position when the first damper component (2) is moved relative to the second damper component (3) in the first direction of rotation and automatically assume the freewheeling position when the first damper component (2) is moved relative to the second damper component (3) in the second direction of rotation.

4. The rotary damper (1) according to claim 3,
wherein the coupling mechanism (5) comprises at least one blocking body (6), which is mounted floatingly in such a way that the blocking body (6) is transferable between an engaged position and a freewheeling position, wherein, upon a movement of the first damper component (2) relative to the second damper component (3) in the first direction of rotation, the at least one blocking body (6) is in the engaged position, in which the at least one blocking body (6) is operatively connected in a form-fit manner to the second damper component (3), and wherein, upon a movement of the first damper component (2) relative to the second damper component (3) in the second direction of rotation, the at least one blocking body (6) is in the freewheeling position, in which a form-fit operative connection between the at least one blocking body (6) and the second damper component (3) is released or prevented,
wherein the at least one blocking body (6) is preferably configured so as to automatically assume the engaged position when the first damper component (2) is moved relative to the second damper component (3) in the first direction of rotation and automatically assume the freewheeling position when the first damper component (2) is moved relative to the second damper component (3) in the second direction of rotation.

5. The rotary damper (1) according to claim 4,
wherein the at least one blocking body (6) comprises a preferably cylindrical or at least substantially cylindrical base body (7), wherein the base body (7) is provided with at least one first toothing (8) on its lateral surface, which toothing is configured so to engage in a form-fit manner or at least substantially in a form-fit manner with an engagement structure (10) of the second damper component (3) in the engaged position of the at least one blocking body (6).

6. The rotary damper (1) according to claim 5,
wherein the engagement structure (10) of the second damper component (3) comprises at least one toothing (11), which is at least substantially complementary to the at least one first toothing (8) of the blocking body (6).

7. The rotary damper (1) according to claim 6,
wherein the at least one first toothing (8) of the base body (7) of the at least one blocking body (6) comprises at least a first tooth and a plurality of first teeth in particular distributed in an equidistant manner over a circumference of the lateral surface of the base body (7), wherein the at least one first tooth of the at least one first toothing (8) of the base body (7) of the blocking body (6) comprises a steep flank and a flat flank.

8. The rotary damper (1) according to claim 7,
wherein the at least one first toothing (8) of the base body (7) of the at least one blocking body (6) is operatively connected to the damping mechanism (4) at least in the engaged position of the at least one blocking body (6) in such a way that a rotational movement of the second damper component (3) relative to the damping mechanism (4) is interrupted or prevented, while a rotational movement of the first damper component (2) relative to the damping mechanism (4) is still possible, in particular with simultaneous conversion of kinetic energy of the first damper component (2), in particular into friction work or heat.

9. The rotary damper (1) according to claim 5,
wherein the at least one blocking body (6) is mounted floatingly, in particular with respect to the second damper component (3), and the at least one first toothing (8) of the blocking body (6) and the engagement structure (10) of the second damper component (3) are configured such that, upon a movement of the first damper component (2) relative to the second damper component (3) in the second rotational direction, the at least one first toothing (8) of the blocking body (6) is or can be slid over the engagement structure (10) of the second damper component (3), while, upon a movement of the first damper component (2) relative to the second damper component (3) in the first rotational direction, the at least one first toothing (8) of the blocking body (6) strikes against a toothing (11) of the engagement structure (10) of the second damper component (3), establishes a form fit therewith, and interrupts a rotation of the second damper component (3) relative to the damping mechanism (4).

10. The rotary damper (1) according to claim 1,
wherein the damping mechanism (4) comprises a fin or rib structure (12) made of an elastically deformable plastic material, wherein, at least upon movement of the first damper component (2) relative to the second damper component (3) in the first direction of rotation, the fin or rib structure (12) of the damping mechanism (4) cooperates with the first damper component (2) in such a way that at least a portion of kinetic energy of the first damper component (2) is converted into heat and/or deformation work by cooperating with the fin or rib structure (12) of the damping mechanism (4).

11. The rotary damper (1) according to claim 10,
wherein the damping mechanism (4) further comprises a bearing structure (13) for the fin or rib structure (12), wherein the bearing structure (13) for the fin or rib structure (12) comprises an engagement structure (14) via which the bearing structure (13) of the damping mechanism (4) and the fin or rib structure (12) supported by the bearing structure (13) are operatively connected via the coupling mechanism (5) to the second damper component (3).

12. The rotary damper (1) according to claim 11,
wherein the base body (7) of the at least one blocking body (6) is provided with a second toothing (9) on its lateral surface, which toothing is configured so as to be operatively connected to the engagement structure (14) of the bearing structure (13) of the damping mechanism (4) at least in the engaged position of the at least one blocking body (6) in a substantially form-fit manner.

13. The rotary damper (1) according to claim 11,
wherein the bearing structure (13) of the damping mechanism (4), and in particular the engagement structure (14) of the bearing structure (13) of the damping mechanism (4), comprises a toothing that is configured at least partially or regionally complementary to the second toothing (9) of the at least one blocking body (6) and is configured so as to establish a form-fit or at least substantially form-fit connection with the at least one blocking body (6) at least in the engaged position of the at least one blocking body (6) and in the engaged position as well as a freewheeling position of the at least one blocking body (6).

14. The rotary damper (1) according to claim 4,
wherein the at least one blocking body (6) is mounted floatingly in a guide (15) configured as an elongated hole such that the blocking body (6) is in its engaged position in a position closer to the engagement structure (10) of the second damper component (3) compared to the position in which the blocking body (6) is in a freewheeling position.

15. The rotary damper (1) according to claim 1,
wherein the first damper component (2) is operatively connected to the damping mechanism (4) such that, at least upon a movement of the first damper component (2) relative to the second damper component (3) in the first direction of rotation, the degree of freedom of a movement, in particular a rotational movement, of the first damper component (2) relative to the damping mechanism (4) is given, wherein such a relative movement is braked or reduced with the aid of the damping mechanism (4) by the conversion of kinetic energy into deformation work and/or heat.

16. The rotary damper (1) according to claim 1,
wherein the first damper component (2) is configured as an in particular cylindrical hollow body,
wherein the damping mechanism (4) is in particular partially or regionally received in the in particular cylindrical hollow body of the first damper component (2), and
wherein the second damper component (3) is arranged at an end region of the first damper component (2) configured as an in particular cylindrical hollow body, wherein the second damper component (3) is connected, and in particular operatively connected, via the coupling mechanism (5) to the first damper component (2) and/or to the damping mechanism (4).

17. The rotary damper (1) according to claim 16,
wherein the damping mechanism (4) is received in the in particular cylindrical hollow body of the first damper component (2) coaxially or concentrically.
